(19) United States
(12) Patent Application Publication
(10) Pub. No.: US 2014/0146688 A1
(43) Pub. Date: May 29, 2014

(54) REPLICA DEPLOYMENT METHOD AND RELAY APPARATUS

(71) Applicant: FUJITSU LIMITED, Kawasaki-shi (JP)

(72) Inventors: Munenori MAEDA, Yokohama (JP); Jun Kato, Kawasaki (JP); Tatsuo Kumano, Kawasaki (JP); Masahisa Tamura, Kawasaki (JP); Ken Iizawa, Yokohama (JP); Yasuo Noguchi, Kawasaki (JP); Toshihiro Ozawa, Yokohama (JP); Kazuichi Oe, Yokohama (JP); Kazutaka Ogihara, Hachioji (JP)

(73) Assignee: FUJITSU LIMITED, Kawasaki-shi (JP)

(21) Appl. No.: 14/047,538

(22) Filed: Oct. 7, 2013

(30) Foreign Application Priority Data
Nov. 29, 2012 (JP) 2012-261748

(51) Int. Cl. H04L 12/24; H04L 12/26

(52) U.S. Cl. CPC H04L 41/06; H04L 43/0817
USPC 370/243

(57) ABSTRACT

A first information processing apparatus transmits a message storing a replica of data stored in the first information processing apparatus. The message has an unspecified destination. A first relay apparatus detects a second information processing apparatus provided in a network to which the first relay apparatus belongs. The first relay apparatus selects, as a transfer destination of the message, the second information processing apparatus or a second relay apparatus upon receiving the message. The first relay apparatus transfers the message to the selected transfer destination. The second information processing apparatus stores the replica therein upon receiving the message.

### CROSS-REFERENCE TO RELATED APPLICATION

This application is based upon and claims the benefit of priority of the prior Japanese Patent Application No. 2012-261748, filed on Nov. 29, 2012, the entire contents of which are incorporated herein by reference.

### FIELD

The embodiment discussed herein is related to a replica deployment method and a relay apparatus.

### BACKGROUND

In an information processing apparatus, such as a server and so forth, connected to a network, in order to increase data reliability or processing performance, a duplicate (replica) of data is deployed (stored) in one or more information processing apparatuses located on the network. When a replica of data is deployed in other information processing apparatuses in the foregoing manner, a risk that loss of data due to a network failure, a failure of a storage device that stores data, or the like is caused may be reduced.

A deployment (storage) destination of a replica is normally determined in advance. Loss of data might be caused by an emergency event, such as a natural disaster, terrorism or some other man-caused disaster, and so forth. It is difficult to predict in advance a place (range) where such an emergency event occurs. Thus, when an emergency event occurs, it might not be able to place the replica in the deployment destination. Therefore, it is preferable to further reduce the probability that data is lost.

Related techniques are disclosed in, for example, Japanese Laid-open Patent Publication No. 2006-146293, Japanese Laid-open Patent Publication No. 2003-32290, Japanese Laid-open Patent Publication No. 2005-4243, and International Publication Pamphlet No. WO04/053696.

### SUMMARY

According to an aspect of the present invention, provided is a replica deployment method. In the method, a first information processing apparatus transmits a message storing a replica of data stored in the first information processing apparatus. The message has an unspecified destination. A first relay apparatus detects a second information processing apparatus provided in a network to which the first relay apparatus belongs. The first relay apparatus selects, as a transfer destination of the message, the second information processing apparatus or a second relay apparatus upon receiving the message. The first relay apparatus transfers the message to the selected transfer destination. The second information processing apparatus stores the replica therein upon receiving the message.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a network system to which a replica deployment method according to an embodiment is applicable;

FIG. 2 is a diagram illustrating an exemplary configuration of a replica duplicate packet;

FIG. 3 is a diagram illustrating an exemplary configuration of a server;

FIG. 4 is a diagram illustrating an exemplary configuration of a router that serves as a relay apparatus according to an embodiment;

FIG. 5 is a diagram illustrating an exemplary structure of a prospective server table;

FIG. 6 is a diagram illustrating a method for obtaining communication statistic data;

FIG. 7 is a diagram illustrating an exemplary structure of a geo-table;

FIG. 8 is a flowchart of transfer control;

FIG. 9 is a diagram illustrating an exemplary transfer sequence of a replica duplicate packet; and

FIG. 10 is a diagram illustrating an exemplary transfer sequence of a replica duplicate packet.

### DESCRIPTION OF EMBODIMENTS

An embodiment will be hereinafter described in detail with reference to the accompanying drawings.

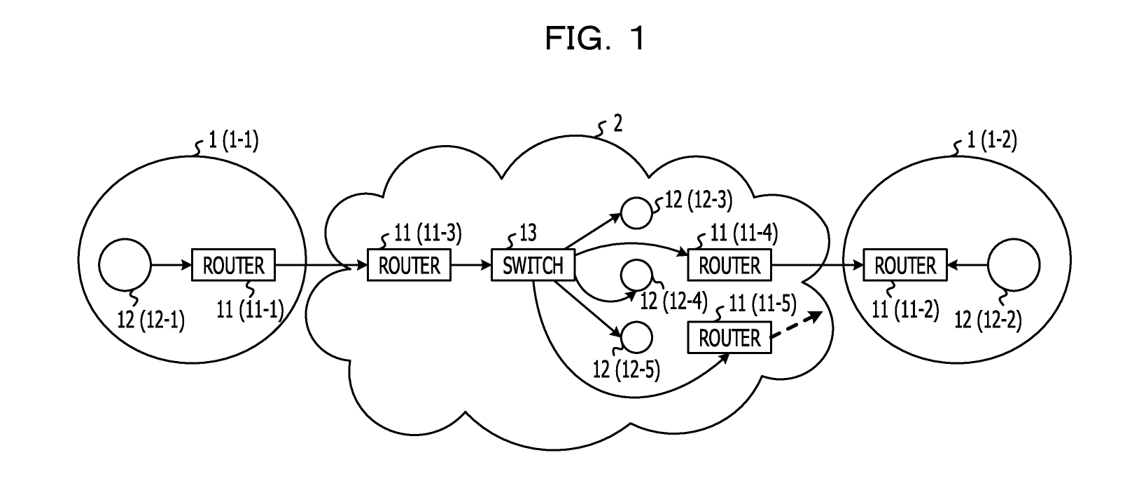

FIG. 1 is a diagram illustrating an exemplary configuration of a network system to which a replica deployment method according to the present embodiment is applicable.

In the replica deployment method according to the present embodiment, each information processing apparatus may automatically select another information processing apparatus which is considered suitable as a deployment destination of a replica to be deployed, and place the replica in the selected information processing apparatus. A network system to which the above replica deployment method is applicable is, as illustrated in FIG. 1, a wide area network (WAN) 2 including a plurality of local area networks (LANs) 1 (1-1, 1-2).

Each of the LANs 1 is connected to the WAN 2 via a router 11. Each of the LANs 1 includes one or more servers 12. Each of the LANs 1 may include a switch or the like as a relay apparatus other than the router 11.

The LAN 1-1 includes a server (hereinafter referred to as a “replica source server”) 12-1 that serves as a transmission source of replica to be deployed, and the LAN 1-2 includes a server (hereinafter referred to as a “replica destination server”) 12-2 that serves as a deployment destination where the replica is placed. Thus, in FIG. 1, the LAN 1-1 and the LAN 1-2 are illustrated separately from the WAN 2. In the present embodiment, for convenience, only the servers 12 are assumed as an information processing apparatus having data to be stored and an information processing apparatus that serves as a deployment destination of the replica. Unless specifically limited, the replica source server and the replica destination server may be referred to as the replica source server 12 and the replica destination server 12.

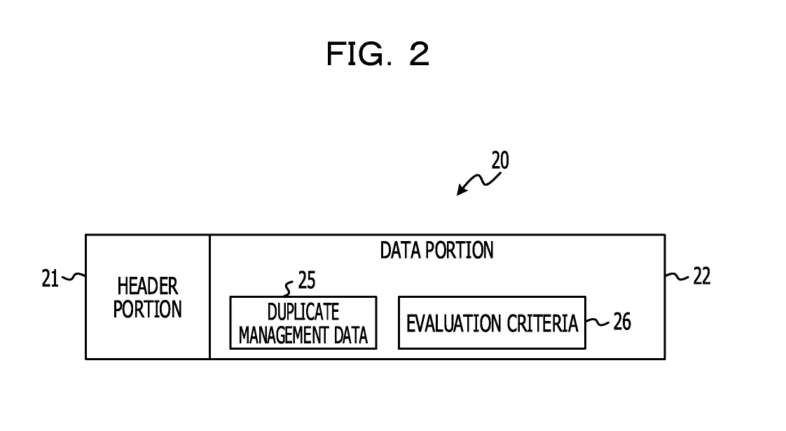

In the present embodiment, the replica source server 12 that transmits replica to be deployed transmits, as a message that stores the replica, a replica duplicate packet 20 having the configuration illustrated in FIG. 2. As illustrated in FIG. 2, the replica duplicate packet 20 includes a header portion 21 and a data portion 22. The data portion 22 contains, in addition to replica to be deployed, duplicate management data 25 and evaluation criteria 26. The replica to be deployed will be referred to as a “deployed replica”.

For example, one of the servers 12 that is instructed by an operator may create and transmit the replica duplicate packet 20 illustrated in FIG. 2. Each of the servers 12 may automatically create and transmit the replica duplicate packet 20 when a predetermined condition is satisfied.

The duplicate management data 25 includes identification data by which the replica source server 12 is identified, a sequence number used for identifying, for example, a type of deployed replica stored in the data portion 22, and so forth. Thus, when the replica destination server 12 is determined, the duplicate management data 25 enables communication between the replica source server 12 and the replica destination server 12 and also enables storing of the deployed replica in the replica destination server 12 in a suitable manner.

In the present embodiment, as the above-described identification data, universal unique identifier (UUID) is employed. This is because, the UUID may provide, even without control, identification data that is uniquely identified.

In order not to cause loss of data, there might be cases where a condition is to be satisfied. For example, when an emergency event occurs due to a natural disaster, such as an earthquake, a flooding, and so forth, a server 12 located at a location distant from the replica source server 12 may be preferably selected as the replica destination server 12. In addition, when such an emergency event occurs, normally, there is only a little time. Therefore, when the deployed replica is relatively large, a certain amount of throughput is to be ensured. Thus, in the present embodiment, the data portion 22 is configured to contain the evaluation criteria 26 for selecting a server 12 that is preferable as the replica destination server 12.

Examples of data in the evaluation criteria 26 may include a delay time, a reliability degree, a throughput, a storage cost, an upper limit of time, and so forth. The delay time and the throughput are used for specifying conditions that the replica destination server 12 is to satisfy to complete placing the deployed replica. The reliability degree indicates the importance of the deployed replica. Thus, the reliability degree is used for specifying a certainty, that is, for example, an availability ratio, a mean time between failures (MTBF), or the like, which the replica destination server 12 is expected to satisfy. The storage cost is used for limiting the replica destination server 12 on the basis of the cost spent for placing the deployed replica. The upper limit of time is a maximum time taken to complete duplication of the deployed replica. By specifying the upper limit of time, the range of a server 12 that may be selected as the replica destination server 12 is limited. A reason why the upper limit of time is taken into consideration is that, in an emergency event, it is reasonable to consider that a time allowed for packet transmission performed by the replica source server 12-1 is limited.

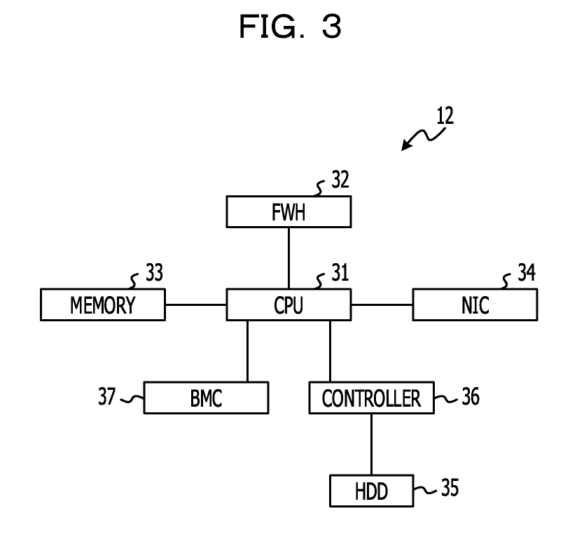

FIG. 3 is a diagram illustrating an exemplary configuration of a server. As illustrated in FIG. 3, a server 12 which may be used as the replica source server 12 or the replica destination server 12 includes a central processing unit (CPU) 31, a firmware hub (FWH) 32, a memory module (memory) 33, a network interface card (NIC) 34, a hard disk drive (HDD) 35, a controller 36, and a baseboard management controller (BMC) 37. This configuration is merely an example, and the configuration of the server 12 is not limited thereto.

The FWH 32 is a memory that stores a basic input/output system (BIOS). The BIOS is read out to the memory module 33 and executed by the CPU 31. The hard disk drive 35 stores an operating system (OS) and various types of application programs. The CPU 31 may read out the OS from the hard disk drive 35 via a controller 36 and execute the OS, after a start-up of the BIOS is completed. Communication via the NIC 34 is enabled by a start-up of the BIOS.

A program for creation and transmission of the replica duplicate packet 20 or a program for storing deployed replica upon receiving the replica duplicate packet 20 may be incorporated, for example, in the OS. Such a program may be realized as an application program or a sub-program that is to be incorporated in an application program.

The BMC 37 is a device used for managing the servers 12. The BMC 37 has a communication function and may perform communication with a console or an external management device via a communication line (not illustrated). A notification of the occurrence of an emergency event, an instruction for responding to an emergency event, or the like may be given, for example, to the BMC 37. That is, the CPU 31 may respond to an emergency event, for example, in accordance with the instruction given via the BMC 37.

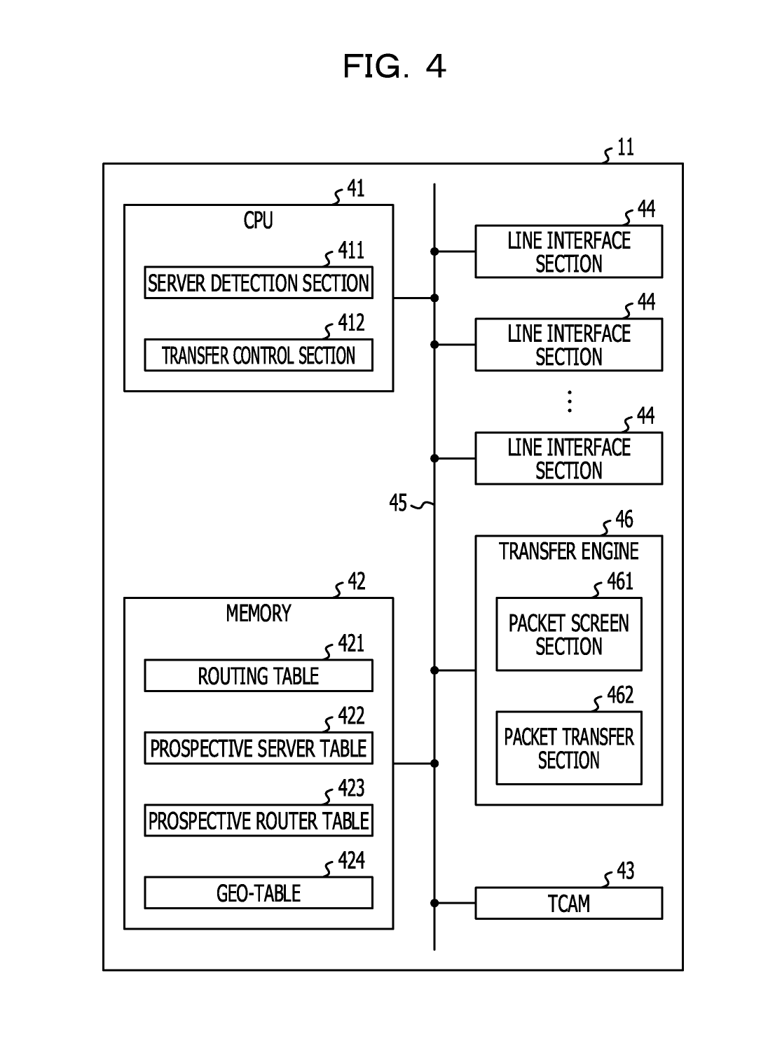

FIG. 4 is a diagram illustrating an exemplary configuration of a router that serves as a relay apparatus according to the present embodiment. As illustrated in FIG. 4, the router 11 includes a CPU 41, a memory module 42, a ternary content addressable memory (TCAM) 43, a plurality of line interface sections 44, a data bus 45, and a transfer engine 46.

The CPU 41 executes a program (hereinafter referred to as a “firmware”) stored, for example, in the memory module 42. By executing the firmware, the CPU 41 functions as a server detection section 411 and a transfer control section 412. The details of each of the server detection section 411 and the transfer control section 412 will be described later.

The memory module 42 is used not only for storing the firmware, but also for storing various types of data used in the router 11. Examples of the data include a routing table 421, a prospective server table 422, a prospective router table 423, a geo-table 424, and so forth.

The routing table 421 is a table that stores routing information which is referred to when the transfer engine 46 performs the routing.

The prospective server table 422 is a table that stores a result of detecting a server 12 that may be a transfer destination of the replica duplicate packet 20 in the LAN 1 to which the router 11 belongs. The prospective server table 422 is created and updated by the server detection section 411.

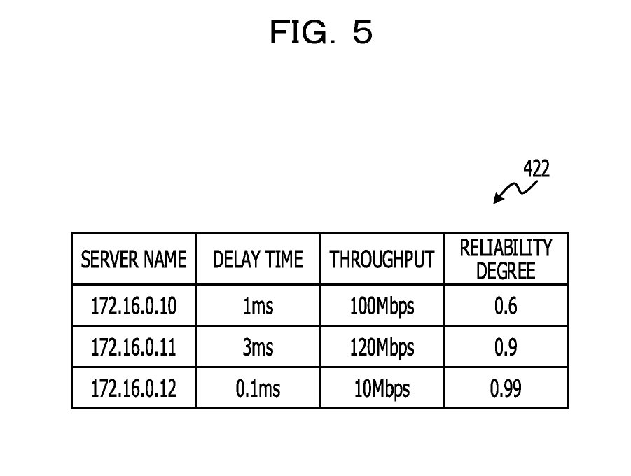

FIG. 5 is a diagram illustrating an exemplary structure of a prospective server table.

As illustrated in FIG. 5, in the prospective server table 422, an entry (record) is stored for each of detected servers 12. Each entry contains data about a server name, a delay time, a throughput, a reliability degree, and so forth.

The server name is identification data that uniquely indicates a detected server 12. In the present embodiment, an Internet Protocol (IP) address is employed as the server name.

The delay time is a period of time from the time of transmitting a message to a detected server 12 to the time of receiving a response of the server 12. The throughput is a data amount that may be processed by a detected server 12 in a unit time. The reliability degree is, for example, an availability ratio (a value ranging from 0 to 1). The above-described types of data are of communication statistic data that may be obtained by using an existing network diagnosis program.

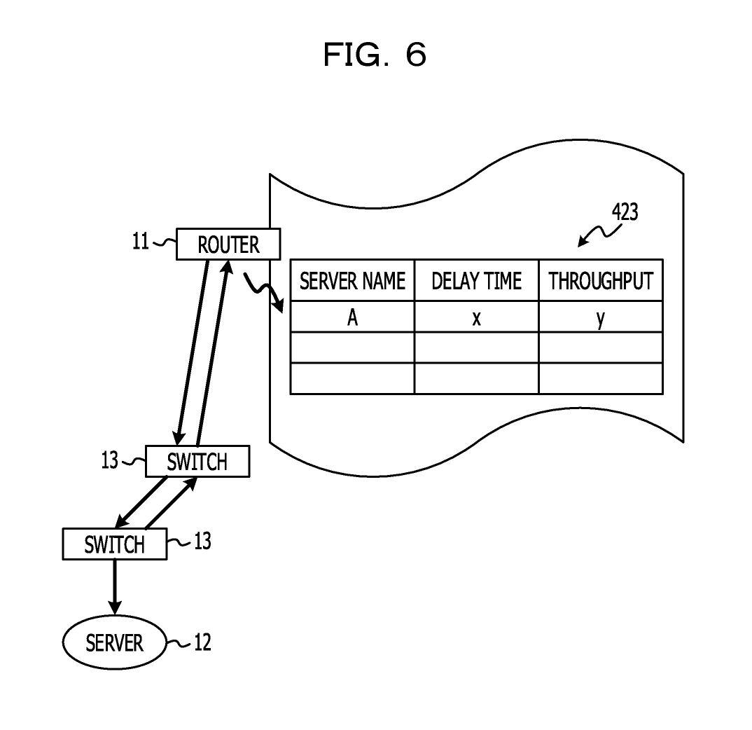

FIG. 6 is a diagram illustrating a method for obtaining communication statistic data. As illustrated in FIG. 6, various types of communication statistic data may be obtained by transmitting a message from the router 11 to a detected server 12. In the example illustrated in FIG. 6, a message is transmitted between the router 11 and the detected server 12 via two switches 13.

The prospective router table 423 is a table in which a router name and various types of communication statistic data are stored for each of other routers 11 with which the router 11 may directly communicate. The various types of communication statistic data may be obtained using an existing network diagnosis program.

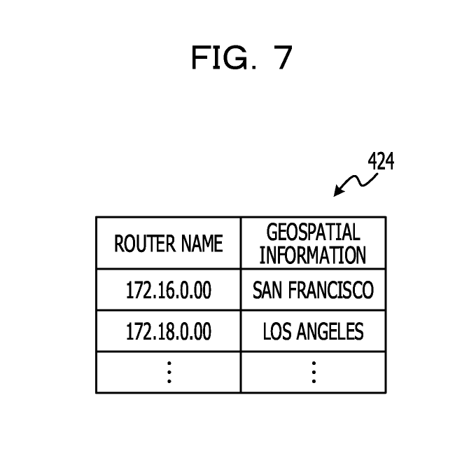

The geo-table 424 is a table in which geospatial information for each router 11 provided on the WAN 2 is stored. FIG. 7 is a diagram illustrating an exemplary structure of the geo-table 424. Each entry of the geo-table 424 contains data about a router name (IP address) and geospatial information indicating the installation site thereof.

In FIG. 7, for ease of comprehension, the geospatial information includes “San Francisco” and “Los Angeles” as examples of the installation sites of the routers 11. Reasons why a router 11 is used as the device indicating the geospatial information are that a router 11 relays a packet flowing on the network to which the router 11 belongs to another network, that the installation site of a server 12 on the network to which the router 11 belongs is normally not far from the router 11, and so forth.

The geo-table 424 is preferably in the latest state at all the time. Because of this, a router 11 that is newly added or a router 11 replacing one of the routers 11 may be configured to transmit and receive the geospatial information to and from other routers 11.

A TCAM 43 is a memory to which routing information stored in the routing table 421 is read out when an actual routing is performed by the router 11. Accordingly, when the router 11 performs routing, the router 11 retrieves the routing information read out to the TCAM 43, thereby determining an actual transfer destination of a packet.

Each of the line interface sections 44 is used for connecting the router 11 to an external device which the router 11 may directly transmit and receive a packet to and from. The external device is another router 11, a switch 13, a server 12, or the like. The router 11 performs communication with an external device using any one of the line interface sections 44.

The data bus 45 connects the CPU 41, the memory module 42, the TCAM 43, each of the line interface sections 44, and transfer engine 46 with one another.

When one of the line interface sections 44 receives a packet, the transfer engine 46 refers to the routing information stored in the TCAM 43 to determine the transfer destination of the packet, and causes another one of the line interface sections 44 which corresponds to the determined transfer destination to transmit the packet. The transfer engine 46 includes a packet transfer section 462 in order to perform the above-described routing.

The transfer engine 46 further includes a packet screen section 461. The packet screen section 461 has a function of determining whether or not a packet received by one of the line interface sections 44 is a replica duplicate packet 20. When the packet screen section 461 determines that a packet received by one of the line interface sections 44 is not a replica duplicate packet 20, the packet transfer section 462 performs the routing.

When the packet screen section 461 determines that the packet is a replica duplicate packet 20, the replica duplicate packet 20 is processed by the CPU 41. The transfer control section 412 realized on the CPU 41 determines a transfer destination of the replica duplicate packet 20 and causes the replica duplicate packet 20 to be transferred to the determined transfer destination.

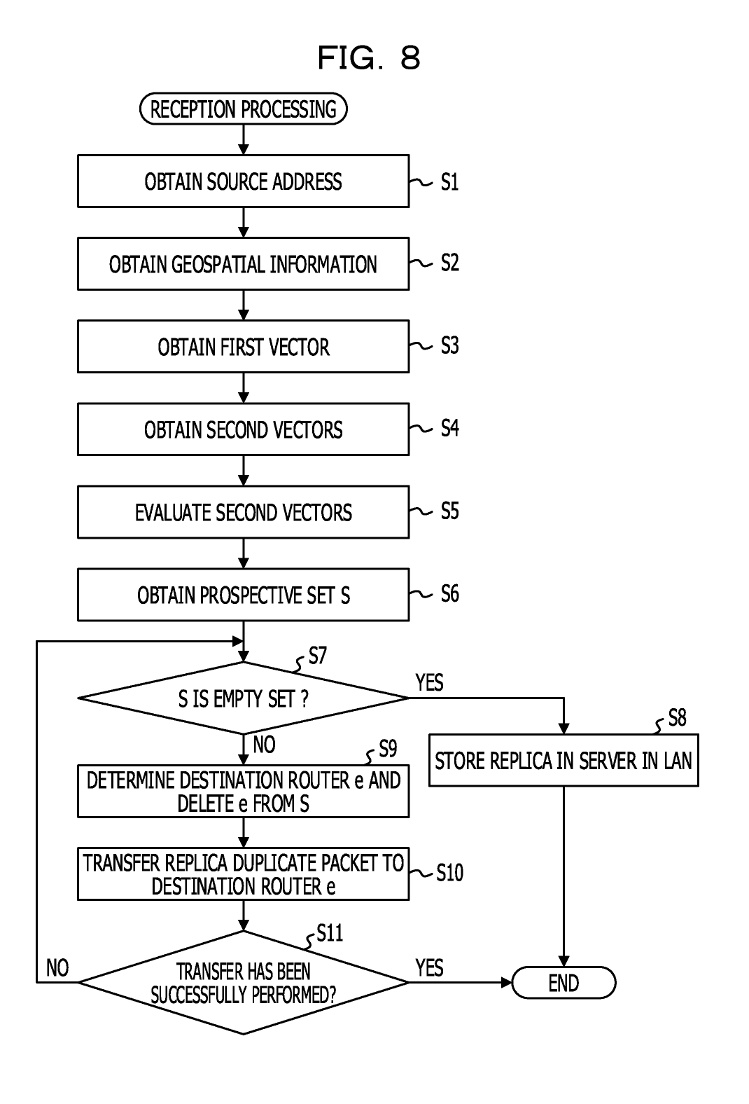

FIG. 8 is a flowchart of transfer control. The transfer control is executed by the CPU 41 when it is notified that the replica duplicate packet 20 has been received from the transfer engine 46. The CPU 41 executes the transfer control, thereby realizing the transfer control section 412. Next, the transfer control will be described in detail with reference to FIG. 8.

First, the CPU 41 obtains an IP address stored as a source address in the header portion 21 of the received replica duplicate packet 20, for example, from the transfer engine 46 (S1). When the replica source server 12 is provided in the LAN 1 to which the router 11 belongs, the IP address obtained in this case is only the IP address of the replica source server 12. When the replica source server 12 is not provided in the LAN 1 to which the router 11 belongs, the CPU 41 obtains, in addition to the IP address of the replica source server 12, the IP address of a router (hereinafter referred to as a “local source router” or a “local source”) 11 which relayed the replica duplicate packet 20 most recently. The following description is given, unless specifically mentioned, assuming a case in which the replica source server 12 is not provided in the network to which the router 11 belongs.

Next, the CPU 41 refers to the geo-table 424 to obtain the geospatial information for each of the two routers 11 (S2). The two pieces of geospatial information are obtained from the IP address of the router (hereinafter referred to as a “global source router” or a “global source”) 11 provided in the network to which the replica source server 12 is belongs, and the IP address of the local source, that is, the router 11 located immediately before the router 11 on the transfer path.

Next, the CPU 41 obtains a straight line connecting the two pieces of geospatial information on a plane as a vector (hereinafter referred to as a “first vector”) of the transfer path of the replica duplicate packet 20 (S3). Thereafter, the CPU 41 refers to the prospective router table 423 to create a list of prospective routers, and refers to the geo-table 424 to obtain, for each of the prospective routers 11, the geospatial information thereof and a vector (hereinafter referred to as a “second vector”), that is, a straight line connecting the router 11 and each of the prospective routers 11 (S4). After the geospatial information and the second vector are obtained for each prospective router 11, the process proceeds to S5.

In S5, the CPU 41 performs evaluation of the obtained second vector for each prospective router 11. The evaluation is performed by calculating an angle made by the first vector and the second vector such that, as the angle is closer to 0, a vector evaluation value increases, and as the angle is closer to 180 degrees, the vector evaluation value reduces. Thus, the replica duplicate packet 20 is transferred to a router 11 located more distant from the replica source server 12.

Next, the CPU 41 refers to evaluation criteria 26 of the replica duplicate packet 20, the prospective router table 423, and the vector evaluation value to further extract routers 11 possibly considered as a transfer destination from the list of the prospective routers 11 (S6). The routers 11 to be extracted are the routers 11 in which the deployed replica will be presumably placed within the upper limit of time specified in the evaluation criteria 26 or an upper limit of time which has been set in advance. This is because, in an emergency event, it is reasonable to consider that a time allowed for the replica source server 12-1 to transmit a packet is limited. A set of extracted routers 11 is referred to as a “prospective set S”. The vector evaluation value may be used as a weight (coefficient) by which each piece of data included in the evaluation criteria 26 is multiplied.

The global source router 11 receives the replica duplicate packet 20 transmitted by the replica source server 12. The first vector is not obtained. Thus, in the global source router 11, normally, all of the routers 11 registered in the prospective router table 423 are extracted. Thus, S1 to S5 is not practically executed.

The CPU 41 that has created the prospective set S next determines whether or not the prospective set S is an empty set (S7). When the prospective set S is an empty set, that is, when there is no router 11 considered as a transfer destination, the determination result in S7 is “Yes” and the process proceeds to S8. When there is a router 11 considered as a transfer destination, the determination result in S7 is “No” and the process proceeds to S9.

In S8, the CPU 41 refers to the prospective server table 422 to select an optimal server 12 from the servers 12 which are in operation in the LAN 1 to which the router 11 belongs, and transfers the replica duplicate packet 20 to the selected server 12. Thereafter, the transfer control is ended. If the prospective set S is an empty set, the replica duplicate packet 20 may be transferred to a server 12 located more distant from the replica source server 12 by selecting the optimal server 12 from the servers 12 which are in operation in the LAN 1 to which the router 11 belongs.

On the other hand, in S9, the CPU 41 determines a router 11 (represented by “ROUTER e” in FIG. 8) that is to be a transfer destination among the routers 11 in the prospective set S and deletes the determined router 11 from the prospective set S. Next, the CPU 41 transfers the replica duplicate packet 20 to the determined router 11 (S10). The CPU 41 which has performed the transfer monitors a response from the router 11 and determines whether or not the transfer has been successfully performed. When a response indicating the success of the transfer is received from the transfer destination to which the replica duplicate packet 20 has been transferred, the determination result in S11 is “Yes”, and the transfer control is ended. When a response indicating the success of the transfer is not received from the transfer destination to which the replica duplicate packet 20 has been transferred, the determination result in S11 is “No”, and the process returns to S7. Thus, the replica duplicate packet 20 is transferred to another router 11 until the prospective set S becomes empty or until transfer of the replica duplicate packet 20 is ended. As a result, the replica duplicate packet 20 is transferred in the direction in which the distance from the replica source server 12 increases.

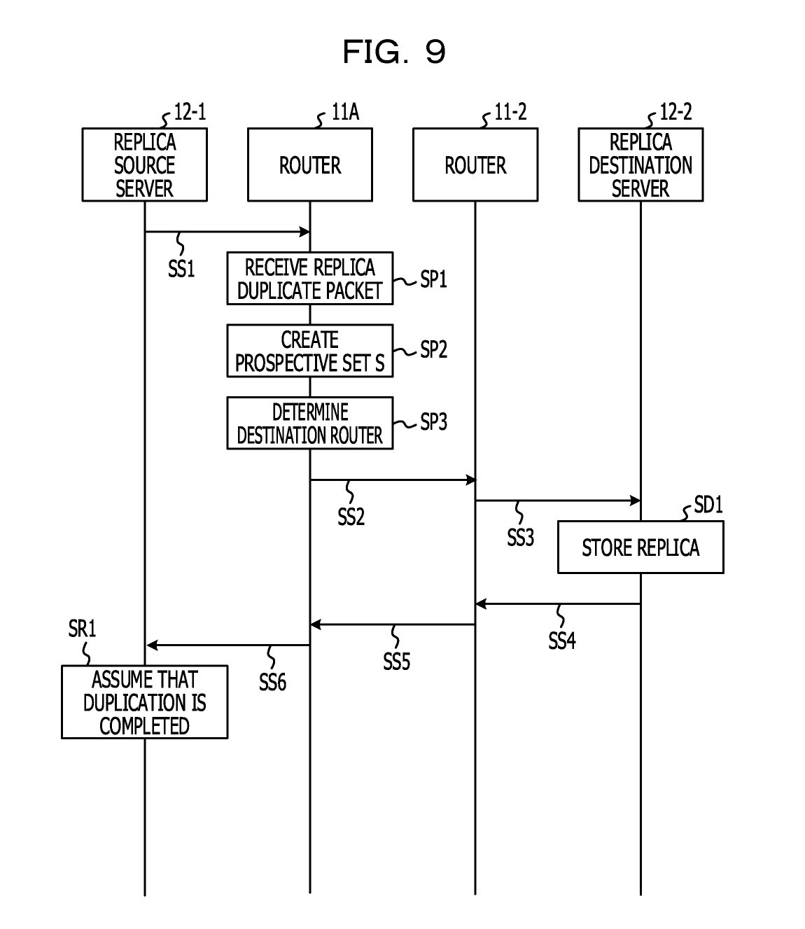

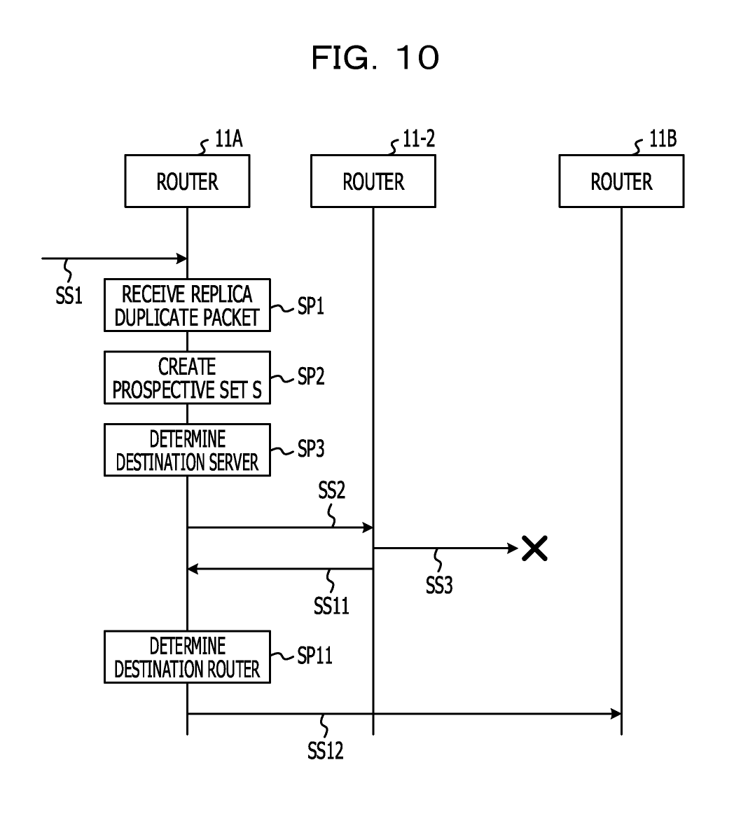

Next, a transfer sequence of relaying a replica duplicate packet between routers 11 will be specifically described with reference to FIG. 9 and FIG. 10.

FIG. 9 is a diagram illustrating an exemplary transfer sequence of a replica duplicate packet when no failure occurs in the transfer of a replica duplicate packet. In FIG. 9, it is assumed that the server 12-1 serves as the replica source server 12, and the server 12-2 serves as the replica destination server 12. The routers 11A and 11-2, which are two routers located immediately before the replica destination server 12-2 on the transfer path of the replica duplicate packet 20, are assumed as the routers 11 which relay the replica duplicate packet 20 between the replica source server 12-1 and the replica destination server 12-2. The operation example of the replica source server 12-1, the two routers 11A and 11-2, and the replica destination server 12-2 will be specifically described with reference to FIG. 9.

In response to an instruction of an operator or the like, the replica source server 12-1 creates a replica duplicate packet 20 that stores deployed replica, as illustrated in FIG. 2, and transmits the replica duplicate packet 20. The CPU 41 of each of the routers 11 which received the replica duplicate packet 20 executes the above-described transfer control. Thus, the replica duplicate packet 20 is transferred to the router 11A (SS1).

The router 11A receives the replica duplicate packet 20 and the CPU 41 in the router 11A is notified that the replica duplicate packet 20 has been received (SP1). Thus, the CPU 41 starts the transfer control and creates a prospective set S (SP2). After creating the prospective set S, the CPU 41 determines the router 11-2 as a transfer destination of the replica duplicate packet 20 among the routers in the prospective set S (SP3). As a result, the replica duplicate packet 20 is transferred from the router 11A to the router 11-2 (SS2).

In the router 11-2, similar to the router 11A, the CPU 41 starts the transfer control. However, the prospective set S has become empty, and the CPU 41 determines, as the replica destination server 12-2, an optimal server 12 among the servers 12 registered in the prospective server table 422. As a result, the replica duplicate packet 20 is transferred from the router 11-2 to the replica destination server 12-2 (SS3).

The replica destination server 12-2 extracts the deployed replica stored in the data portion 22 of the replica duplicate packet 20 and stores the extracted deployed replica in a storage device (SD1). When the replica destination server 12-2 has the configuration illustrated in FIG. 3, the replica duplicate packet 20 is received by the NIC 34 and is output from the NIC 34 to the CPU 31. The CPU 31 extracts the deployed replica which is stored in the data portion 22 of the replica duplicate packet 20 input from the NIC 34 and, and causes the hard disk drive 35 to store the extracted deployed replica via the controller 36. Thereafter, the CPU 31 causes the NIC 34 to transmit, as a response to the replica duplicate packet 20, a message (hereinafter referred to as a “duplication completion packet”) which indicates duplication of the deployed replica is completed. As a result, the duplication completion packet is transmitted from the replica destination server 12-2 to the router 11-2 (SS4).

Upon receiving the duplication completion packet, the router 11-2 transfers the received duplication completion packet to the router 11A (SS5). The router 11A also transfers the received duplication completion packet to another router 11 located immediately before the router 11A on the transfer path of the replica duplicate packet 20. Thus, the duplication completion packet is transferred to the replica source server 12-1 inversely following the transfer path of the replica duplicate packet 20 (SS6).

When the number of the transmitted replica duplicate packets 20 is only one, the replica source server 12-1 which received the duplication completion packet assumes that duplication of the deployed replica is completed (SR1). Normally, the whole deployed replica is not transmitted by 1 packet. Thus, when all packets (responses) are received, each of which indicates that a packet storing the deployed replica has been appropriately processed, it is determined that duplication of the deployed replica is completed.

In transmitting the deployed replica divided into a plurality of replica duplicate packets 20, there is a probability that a duplication completion packet is received before all pieces of the deployed replica are transmitted. In such a case, transmission of a remaining part of deployed replica may be performed using a normal packet whose transmission destination is the replica destination server 12-2 that is identified based on the duplication completion packet.

FIG. 10 is a diagram illustrating an exemplary transfer sequence of a replica duplicate packet when a failure occurs in the transfer of the replica duplicate packet. The example of the transfer sequence illustrated in FIG. 10 is used when transfer of the replica duplicate packet 20 from the router 11-2 to the replica destination server 12-2 has failed. With focus on a part of the transfer in which a failure has occurred, FIG. 10 only illustrates, the routers 11A and 11-2, and the router 11B determined as a transfer destination that substitutes the router 11-2. Only a part of the transfer sequence after a failure has occurred in the transfer of the replica duplicate packet 20 will be described with reference to FIG. 10.

When the server 12 determined as the replica destination server 12-2 is not normally operating, that is, when the server 12 is not operating, or when a failure occurs in the server 12, and so forth, the router 11-2 does not receive the duplication completion packet. Thus, the router 11-2 transmits a response indicating that the transfer of the replica duplicate packet 20 has failed to the router 11A (SS11). As a result, the router 11A determines, as a transfer destination of the replica duplicate packet 20, another router 11B from the routers in the prospective set S (SP11). As a result, the replica duplicate packet 20 is transferred from the router 11A to the router 11B (SS12).

When the router 11-2 detects servers 12 other than the replica destination server 12-2, the router 11-2 selects a server 12 which may be selected as a transfer destination of the replica duplicate packet 20, and transfers the replica duplicate packet 20 to the selected server 12. Therefore, the failure in the transfer illustrated in FIG. 10 means that the router 11-2 is in a state where all of servers 12 that may be selected as a transfer destination of the replica duplicate packet 20 are not able to normally process the replica duplicate packet 20.

In the example illustrated in FIG. 1, the replica duplicate packet 20 transmitted from the replica source server 12-1 is transferred to the router 11-1, the router 11-3, and then, the switch 13. The switch 13 detects the servers 12-3, 12-4, and 12-5, which are directly or indirectly connected thereto. However, the replica duplicate packet 20 is not transferred to any one of the servers 12-3, 12-4, and 12-5 but is transferred to the router 11-4. Thus, the replica duplicate packet 20 is transferred to the replica destination server 12-2 via the routers 11-4 and 11-2. If transfer to the router 11-4 fails, the switch 13 may select the router 11-5 as the next transfer destination of the replica duplicate packet 20.

Note that, in the present embodiment, the replica duplicate packet 20 is transferred in the direction in which the distance from the replica source server 12 increases, but there may be cases where transfer of the replica duplicate packet 20 is performed in another manner. For example, a boundary from the location of the replica source server 12 is determined for an area in which the replica duplicate packet 20 may be presumably processed and one of the servers 12 located beyond the boundary may be caused to process the replica duplicate packet 20. In this case, data indicating the installation site of the replica source server 12 may be stored in the evaluation criteria 26. As another option, area data that specifies the range of an area where the replica duplicate packet 20 is preferably processed may be configured to be inserted to the evaluation criteria 26, and the server 12 to process the replica duplicate packet 20 may be selected in accordance with the area data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A replica deployment method comprising:
transmitting, by a first information processing apparatus, a message storing a replica of data stored in the first information processing apparatus, the message having an unspecified destination;
detecting, by a first relay apparatus, a second information processing apparatus provided in a network to which the first relay apparatus belongs;
selecting by the first relay apparatus, as a transfer destination of the message, the second information processing apparatus or a second relay apparatus upon receiving the message;
transferring the message to the selected transfer destination by the first relay apparatus; and
storing, by the second information processing apparatus, the replica therein upon receiving the message.

2. The replica deployment method according to claim 1, wherein
the message stores therein criteria for evaluating an information processing apparatus to store the replica, and
the first relay apparatus refers to the criteria stored in the message to select the transfer destination of the message.

3. A relay apparatus comprising:
a processor to
detect a first information processing apparatus provided in a network to which the relay apparatus belongs,
receive a message transmitted from a second information processing apparatus, the message storing a replica of data stored in the second information processing apparatus, the message having an unspecified destination,
select, as a transfer destination of the message, the first information processing apparatus or another relay apparatus upon receiving the message, and
transfer the message to the selected transfer destination.
